(19) United States
(12) Patent Application Publication
(10) Pub. No.: US 2017/0203687 A1
(43) Pub. Date: Jul. 20, 2017

(54) SMART AUTOMOBILE DOOR HANDLE LIGHT

(71) Applicant: Chun-Hsien Kuo, Miaoli County (TW)

(72) Inventor: Chun-Hsien Kuo, Miaoli County (TW)

(21) Appl. No.: 15/399,053

(22) Filed: Jan. 5, 2017

(30) Foreign Application Priority Data
Jan. 20, 2016 (TW) 105101672

(51) Int. Cl. B60Q 3/80; B60Q 3/267; E05B 85/10

(52) U.S. Cl. CPC B60Q 3/80; E05B 85/10; B60Q 3/267

(57) ABSTRACT

A smart automobile door handle light includes a light emitting door handle assembly, a smart central processing unit (CPU), a vehicle condition sensing unit, a mode storage unit and a pulse width modulation (PWM) unit. The light emitting door handle assembly includes a door handle body and a light emitting module provided at the door handle body. The vehicle condition sensing unit is electrically connected to the smart CPU. The mode storage unit provides a plurality of light emitting modes and is electrically connected to the smart CPU. The PWM unit controls brightness and an illumination period of the light emitting module, and is electrically connected to the smart CPU. The smart CPU selects the corresponding light emitting mode according to a sensing signal of the vehicle condition sensing unit, to cause the PWM unit to control the brightness and illumination period of the light emitting module.

### FIELD OF THE INVENTION

The present invention relates to an automobile door handle light, and particularly to a smart automobile door handle light.

### BACKGROUND OF THE INVENTION

A four-wheel vehicle is generally referred to as an automobile. An automobile, being self-powered, is a vehicle that can be driven without relying on tracks or cables. Offering high mobility, automobiles are an essential means of outdoors transportation of the modern people. To enhance the practicability and safety of automobiles, headlights or brake lights are installed to the front and rear of automobiles to illuminate the roads or serve the purpose of alerting others.

In response to increased driving safety requirements, an alert light is also disposed on an automobile handle. For example, the U.S. Patent Publication No. US2006/0282987, “Door-Handle Warning Lamp for an Automobile”, discloses a light emitting warning device provided automobile door handles at two sides of an automobile body. Each automobile handle includes a recessed chamber, in which a plurality of light emitting diodes (LEDs) are disposed. The recessed chamber is covered by a transparent cover. When the automobile turns or the automobile door is opened, these LEDs emit light beams to achieve a warning effect.

Although the LEDs disposed on the automobile door handle may prompt automobiles or people at the sides to pay attention, only one single light emitting alert mode is provided instead of generating different alert modes according to different vehicle conditions. Therefore, there is a need for a solution capable of issuing alerts corresponding to different vehicle conditions.

### SUMMARY OF THE INVENTION

It is an object of the present invention to solve issues of a conventional automobile door handle lamp that is incapable of generating different alert modes according to different vehicle conditions.

To achieve the above object, the present invention provides a smart automobile door handle light including a light emitting door handle assembly, a smart central processing unit (CPU), a vehicle condition sensing unit, a mode storage unit and a pulse width modulation (PWM) unit. The light emitting door handle assembly is disposed at an outer automobile door, and includes a door handle body and a light emitting module provided at the door handle body. The light emitting module includes a plurality of light emitting diodes (LEDs). The vehicle condition sensing unit is electrically connected to the smart CPU. The mode storage unit provides a plurality of light emitting modes, and is electrically connected to the smart CPU. The PWM unit controls brightness and an illumination period of the light emitting module, and is electrically connected to the light emitting module and the smart CPU.

The smart CPU selects a corresponding light emitting mode from the mode storage unit according to a sensing signal of the vehicle condition sensing unit, so as to cause the PWM unit to control the brightness and illumination period of the light emitting module.

In conclusion, the present invention provides following features.

1. By providing the light emitting module at the door handle body, vehicles or pedestrians coming from the sides can be prompted to pay attention.

2. With the PWM unit provided, the brightness and illumination period of the light emitting module may be controlled according to the sensing signal of the vehicle condition sensing unit; that is, corresponding alert modes may be generated according to different vehicle conditions to enhance safety.

### BRIEF DESCRIPTION OF THE DRAWINGS

FIG. 1 is an exploded schematic diagram according to a first embodiment of the present invention;

FIG. 2 is a function block diagram according to the first embodiment of the present invention;

FIG. 3 is a function block diagram according to a second embodiment of the present invention;

FIG. 4 is a perspective structural schematic diagram according to a third embodiment of the present invention; and

FIG. 5 is a function block diagram according to the third embodiment of the present invention.

### DETAILED DESCRIPTION OF THE PREFERRED EMBODIMENTS

Details and technical contents of the present invention are given with the accompanying drawings below.

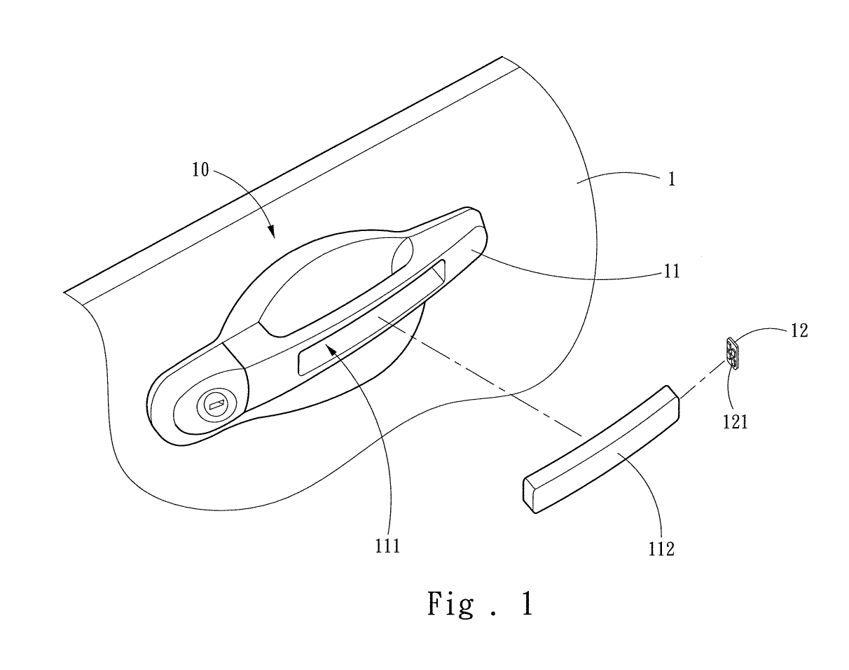

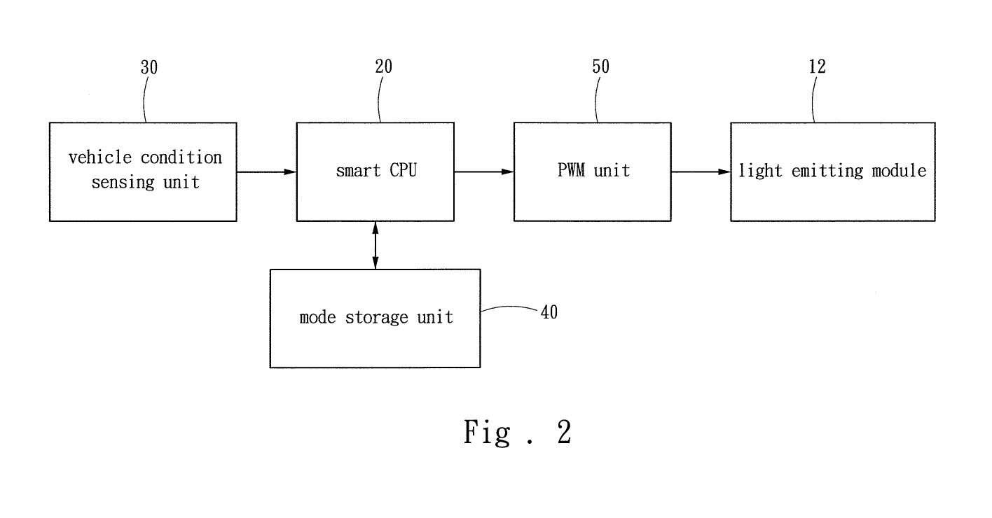

Referring to FIG. 1 and FIG. 2, a smart automobile door handle light of the present invention includes a light emitting door handle assembly 10, a smart central processing unit (CPU) 20, a vehicle condition sensing unit 30 electrically connected to the smart CPU 20, a mode storage unit 40 electrically connected to the smart CPU 20, and a pulse width modulation (PWM) unit 50 electrically connected to the light emitting module 12 and the smart CPU 20. The light emitting door handle assembly 10 is provided at an automobile outer door 1, and includes a door handle body 11 and a light emitting module 12 provided at the door handle body 11. The light emitting module 12 includes a plurality of light emitting diodes (LEDs) 121. The mode storage unit 40 provides a plurality of light emitting modes. The PWM unit 50 controls brightness and an illumination period of the light emitting module 12.

In the embodiment, the door handle body 11 includes a light pervious region 111 and a light guiding column 112 disposed at the light pervious region 111. The light emitting module 12 may be disposed at two opposite sides of the light guiding column 112. In FIG. 1, the light emitting module 12 is disposed at one end of the light guiding column 112 as an example for illustrations. When the LEDs 121 emit light beams, the light beams are reflected in the light guiding column 112 to eventually exit to an exterior to achieve an alerting effect. Thus, the number of the LEDs 121 provided may be decreased to reduce costs. Further, microstructures (not shown) may be provided on the light guiding column 112 to allow light beams to more easily exit.

When the vehicle condition sensing unit 30 senses a vehicle condition change, it issues a sensing signal. From the mode storage unit 40, the smart CPU 20 selects the light emitting mode corresponding to the sensing signal according to the sensing signal, so as to cause the PWM unit 50 to control the brightness and illumination period of the light emitting module 12. Thus, different alert approaches may be generated according to different vehicle conditions to prompt vehicles at the sides to pay attention, thereby enhancing driving safety.

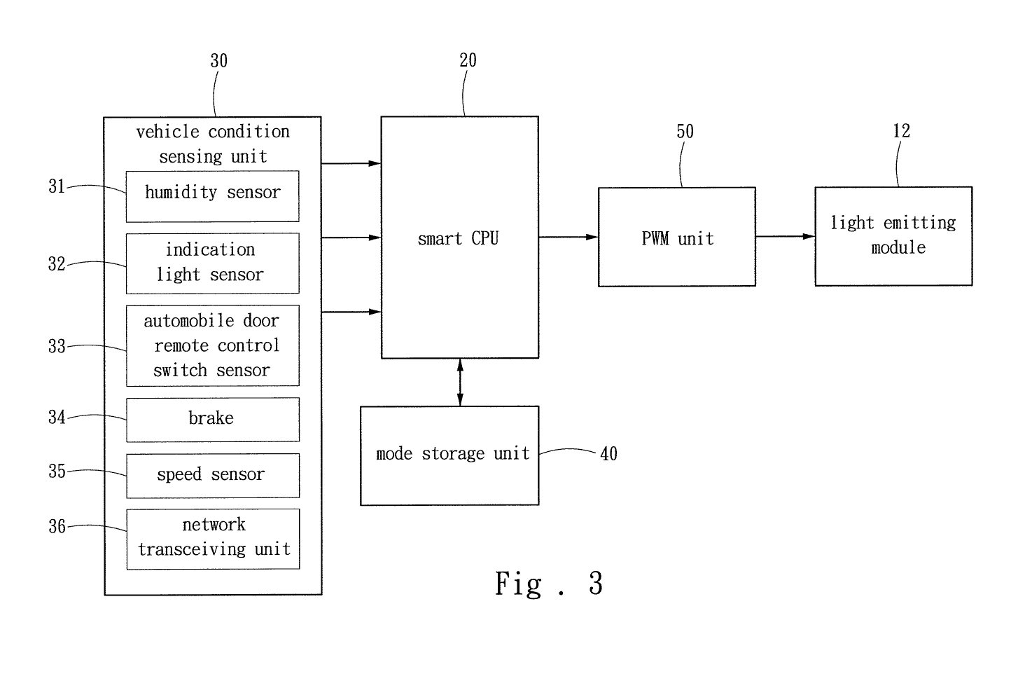

Referring to FIG. 3, the vehicle condition sensing unit 30 may be a humidity sensor 31, an indication light sensor 32, an automobile door remote control switch sensor 33, a brake 34, a speed sensor 35 or a network transceiving unit 36. The humidity sensor 31 is taken as an example for illustrating associated operations. The humidity sensor 31 senses the humidity of the ambient environment to issue the sensing signal. The smart CPU 20 then selects the light emitting mode corresponding to the sensing signal according to the sensing signal, so as to cause the PWM unit 50 to control the brightness and illumination period of the light emitting module 12. For example but not limited to, the light emitting module 12 may flash for a lower humidity sensed, or may constantly illuminate for a higher humidity sensed. Alternatively, the LEDs 121 may achieve different alert modes by incorporating different colors.

Operations of the indication light sensor 32, the automobile door remote control switch sensor 33, the brake 34, the speed sensor 35 and the network transceiving unit 36 are substantially identical to those of the humidity sensor 31, with the variations described below. The indication light sensor 32 causes the light emitting door handle assembly 10 at the right or left side to illuminate for alert according to a right or left turn. The automobile door remote control switch sensor 33 senses an open/close signal of automobile remote control to cause the light emitting module 12 to flash. The brake 34 causes the light emitting module 12 to issue different alerts according to the magnitude of a stepping force a driver applies upon the brake 34. For example, the light emitting module 12 may be constantly illuminated when the brake 34 is lightly stepped, or may flash at a high intensity when the brake 34 is forcibly stepped. The speed sensor 35 causes the light emitting module 12 to issue different alerts according to the automobile speed. For example, the light emitting module 12 issues a green-light alert for a low speed and a red-light alert for a high speed. The network transceiving unit 36 receives environment information of a current location, e.g., rain or fog, to cause the light emitting module 12 to issue different alerts. The above describes examples for illustrations. In practice, colors, brightness and time intervals may be applied in alternate to accordingly achieve the object of smart display.

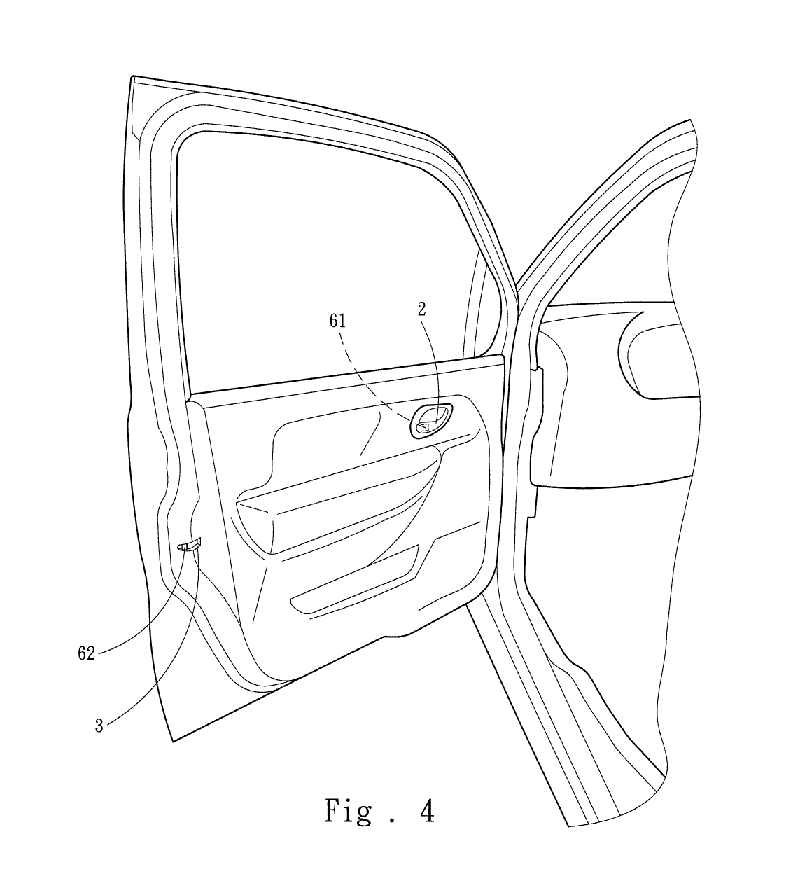

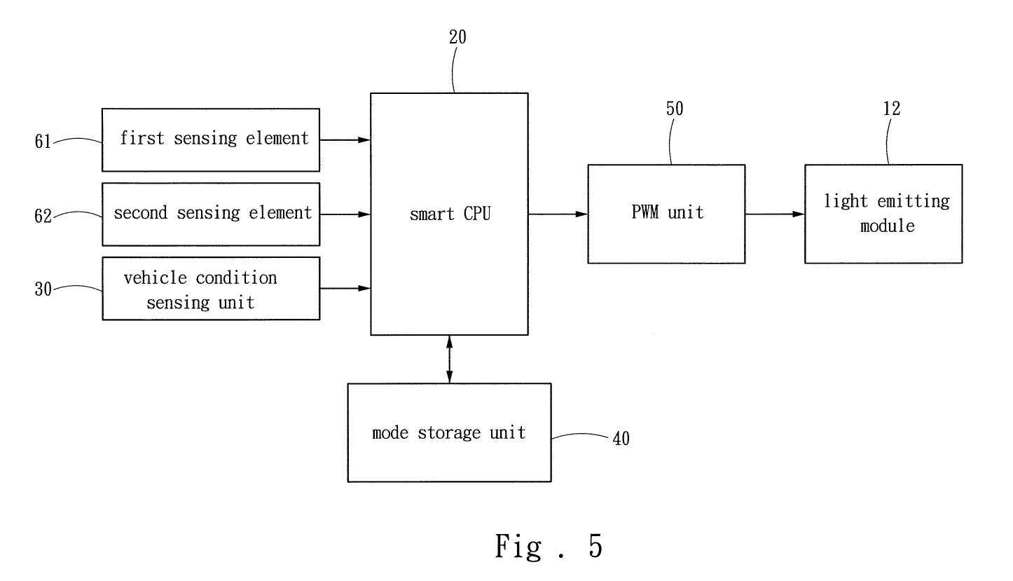

Referring to FIG. 4 and FIG. 5, in this embodiment, the smart automobile door handle light further includes a first sensing element 61 and a second sensing element 62. The first sensing element 61 is disposed at an automobile inner door 2 and senses a touch of a human hand. The second sensing element 62 is disposed at an automobile door switch 3, and senses an open/closed status of the automobile door. The first sensing element 61 and the second sensing element 62 are electrically connected to the smart CPU 20, and respectively include a first-phase light emitting mode and a second-phase light emitting mode corresponding to the mode storage unit 40. For example but not limited to, the first sensing element 61 may be an optical sensor, a temperature sensor, a capacitance sensor or a pressure sensor; the second sensing element 62 may be an optical sensor, a capacitance sensor or a pressure sensor.

Operation principles are further given in detail below. When a human hand touches the first sensing element 61 and has not yet opened the automobile door, the smart CPU 20 causes the PWM unit 50 to control the brightness and illumination period of the light emitting module 12 according to the first-phase light emitting mode; when the automobile door is opened, the smart CPU 20 causes the PWM unit 50 to control the brightness and illumination period of the light emitting module 12 according to the second-phase light emitting mode. For example, when a human hand touches the first sensing element 61 and has not yet opened the automobile door, the light emitting module 12 may flash, so as to alert and prompt vehicles at the side to slow down or move aside; when the automobile door is opened, the light emitting module 12 changes to illuminate constantly to increase visibility. With such two-phase approach, alerts may be provided before and after the automobile door is opened to enhance safety.

In conclusion, the present invention provides following features.

1. By providing the light emitting module at the door handle body, vehicles or pedestrians coming from the sides can be prompted to pay attention.

2. With the PWM unit provided, the brightness and illumination period of the light emitting module may be controlled according to the sensing signal of the vehicle condition sensing unit; that is, corresponding alert modes may be generated according to different vehicle conditions to enhance safety.

3. The smart CPU selects the corresponding light emitting mode according to the sensing signal, so as to cause the PWM unit to control the brightness and illumination period of the light emitting module. Thus, different alert methods may be generated according to different vehicle conditions to prompt vehicles at the side to pay attention, thereby enhancing driving safety.

4. With the first sensing element and the second sensing element disposed, alerts may be provided before and after the automobile door is opened to enhance safety.

What is claimed is:

1. A smart automobile door handle light, comprising:
a light emitting door handle assembly, provided at an automobile outer door, comprising a door handle body and a light emitting module provided at the door handle body, the light emitting module comprising a plurality of light emitting diodes (LEDs);
a smart central processing unit (CPU);
a vehicle condition sensing unit, electrically connected to the smart CPU;
a mode storage unit, providing a plurality of light emitting modes, electrically connected to the smart CPU; and
a pulse width modulation (PWM) unit, controlling brightness and an illumination period of the light emitting module, electrically connected to the light emitting module and the smart CPU;
wherein, the smart CPU selects a corresponding light emitting mode from the mode storage unit according to a sensing signal of the vehicle condition sensing unit, to cause the PWM unit to control the brightness and the illumination period of the light emitting mode.

2. The smart automobile door handle light of claim 1, wherein the door handle body comprises a light pervious region and a light guiding column disposed at the light pervious region, and the light emitting module is disposed at one end of the light guiding column.

3. The smart automobile door handle light of claim 1, further comprising:
a first sensing element, disposed at an automobile inner door, sensing a touch of a human hand; and
a second sensing element, disposed at an automobile door switch, sensing an automobile door open/closed status;
wherein, the first sensing element and the second sensing element respectively correspond to a first-phase light emitting mode and a second-phase light emitting mode of the mode storage unit and are electrically connected to the smart CPU.

4. The smart automobile door handle light of claim 3, wherein the first sensing element is selected from the group consisting of an optical sensor, a temperature sensor, a capacitance sensor and a pressure sensor, and the second sensing element is selected from the group consisting of an optical sensor, a capacitance sensor and a pressure sensor.

5. The smart automobile door handle light of claim 1, wherein the vehicle condition sensing unit is a brake, and the smart CPU selects the corresponding light emitting mode according to a magnitude of a stepping force on the brake.

6. The smart automobile door handle light of claim 1, wherein the vehicle condition sensing unit is a speed sensor, and the smart CPU selects the corresponding light emitting mode according to a speed.

7. The smart automobile door handle light of claim 1, wherein the vehicle condition sensing unit is a humidity sensor, and the smart CPU selects the corresponding light emitting mode according to a humidity of an ambient environment.

8. The smart automobile door handle light of claim 1, wherein the vehicle condition sensing unit is a network transceiving unit that receives environment information of a current location.

9. The smart automobile door handle light of claim 1, wherein the vehicle condition sensing unit is an indication light sensor.

10. The smart automobile door handle light of claim 1, wherein the vehicle condition sensing unit is an automobile door remote control switch sensor that senses an open/close signal of automobile door remote control.
